(19) United States
(12) Patent Application Publication
(10) Pub. No.: US 2026/0262184 A1
(43) Pub. Date: Sep. 3, 2026

(54) INSTRUMENT-STEM INTEGRATED SYSTEM

(71) Applicant: Haoqi LIU, Suzhou (CN)

(72) Inventor: Haoqi LIU, Suzhou (CN)

(21) Appl. No.: 19/657,199

(22) Filed: Apr. 24, 2026

Related U.S. Application Data
(63) Continuation-in-part of application No. 18/287,047, filed on Apr. 15, 2022, now Pat. No. 12,637,162.

(30) Foreign Application Priority Data
Apr. 16, 2021 (CN) 202120780804.3

(51) Int. Cl. H05K 5/06; B62J 6/028; B62J 6/16; B62J 23/00; B62J 50/21; B62J 50/22; F21V 23/00; F21V 23/04; G06F 21/60; H05K 5/02; H05K 7/20

(52) U.S. Cl. CPC H05K 5/061; B62J 6/028; B62J 6/16; B62J 23/00; B62J 50/22; B62J 50/225; F21V 23/001; F21V 23/0464; G06F 21/606; H05K 5/0247; H05K 5/069; H05K 7/20963; G06F 2221/2103

(57) ABSTRACT

An instrument-stem integrated system comprises: a stem body; the stem body serves as a main structural member of the stem and simultaneously constitutes a mounting housing and a heat dissipation substrate for an instrument assembly; an instrument assembly embedded in a cavity on the inner side of the stem body, configured to display vehicle operating information and to execute vehicle-wide control, communication, and unlocking functions; a headlight assembly integrated at a front end of the stem body; the headlight assembly includes a headlight metal housing and a plurality of headlight locking screws; a headlight harness, a main control harness, and a button harness; wherein the instrument assembly comprises a main electronic control board and a secondary electronic control board, the main electronic control board is configured to integrate a main control MCU, a Bluetooth module, and an RFID module, and the instrument assembly communicates with an external controller.

### CROSS-REFERENCE TO RELATED APPLICATIONS

This application is a Continuation-in-part Application of US patent Application No. 18/287,047, filed on October 16, 2023, which is based on the International Application No. PCT/CN2022/087202, filed on April 15, 2022, and claims the priority of Chinese Patent Application No. 202120780804.3, filed on April 16, 2021, the entire contents of which are incorporated herein by reference.

### TECHNICAL FIELD

The present invention relates to the technical field of bicycle instruments, and more particularly, to an instrument-stem integrated system.

### BACKGROUND

With the development of electric bicycles, an increasing number of electronic components are integrated into the vehicle. In addition to motor control, it is generally necessary to provide an instrument, a headlight, buttons, and unlocking-related components to meet the needs of vehicle display, illumination, and daily operation. Meanwhile, user requirements for the overall appearance, structural compactness, and ease of use of the vehicle are continuously increasing. Therefore, how to reasonably arrange the above components in the limited installation space near the handlebar and the stem has become a practical issue to be considered in the art.

Conventionally, the instrument, headlight, and associated harnesses of an electric bicycle are typically arranged separately. For example, the instrument is mounted at the center of the handlebar or above the stem, the headlight is independently mounted at the front of the vehicle body, and harnesses connecting the instrument, controller, buttons, and headlight are routed along the exterior of the handlebar or frame. Meanwhile, the communication method between existing instruments and controllers is often relatively simple, typically adapted to only one type of controller protocol, with limited coordination among different components, and the overall design remains predominantly distributed.

However, the above solutions still have relatively obvious deficiencies in practical use. On the one hand, the separate arrangement of the instrument, headlight, and harnesses makes the structure near the stem appear fragmented, with excessive external wiring, which not only affects the overall appearance of the vehicle, but also increases the complexity of assembly and maintenance; moreover, long-term exposure of harnesses to the elements makes them susceptible to rain, vibration, and pulling, which in turn affects operational reliability. On the other hand, in existing solutions, the instrument and controller can usually only be adapted to a single communication method, which has insufficient compatibility, making it inconvenient when replacing controllers or adapting to different vehicle models; furthermore, existing instruments tend to focus on display functions, with limited participation in vehicle-wide communication management, data processing, and security verification, making it difficult to meet the current demand for integration and intelligence in electric bicycles. Therefore, it is necessary to provide an instrument-stem integrated system that centralizes the instrument, headlight, and associated harnesses in the stem area, while ensuring utilization of installation space, improving the overall vehicle appearance and wiring conditions, and enhancing the overall system integrity and adaptability.

No effective solution has been proposed for the problems in the related art.

### SUMMARY OF THE INVENTION

In view of the problems in the related art, the present invention proposes an instrument-stem integrated system to overcome the above technical problems existing in the related art.

To this end, the present invention adopts the following specific technical solution:

An instrument-stem integrated system, the system comprising: a stem body; the stem body serving as a main structural member of the stem and simultaneously constituting a mounting housing and a heat dissipation substrate for an instrument assembly; an instrument assembly embedded in a cavity on the inner side of the stem body, configured to display vehicle operating information and to execute vehicle-wide control, communication, and unlocking functions; a headlight assembly integrated at a front end of the stem body; the headlight assembly comprising a headlight metal housing and a plurality of headlight locking screws; a headlight harness, a main control harness, and a button harness, all routed out from the interior of the stem body, the headlight harness being configured to connect to a headlight, the main control harness being configured to connect to an external controller, and the button harness being configured to connect to an external button; wherein the instrument assembly comprises a main electronic control board and a secondary electronic control board; the main electronic control board is configured to integrate a main control microcontroller unit (MCU), a Bluetooth module, and a radio frequency identification (RFID) module, the secondary electronic control board is configured to integrate external harness interfaces and to be electrically connected to the main electronic control board; and the instrument assembly communicates with an external controller via a harness or wirelessly.

Further, the instrument assembly further comprises: an upper cover assembly, disposed at the uppermost portion of the instrument assembly and covering an upper side of the main electronic control board; a lower cover, disposed below the upper cover assembly and enclosing together with the upper cover assembly to form a sealed cavity accommodating the main electronic control board and the secondary electronic control board; an upper-lower cover O-ring seal, disposed between the upper cover assembly and the lower cover, configured to provide circumferential waterproof sealing for the sealed cavity; a plurality of upper-lower cover fastening screws, passing through between the upper cover assembly and the lower cover to fasten and secure the two together; a photoresistor light-sensing aperture, disposed on the upper cover assembly at a position corresponding to a photosensitive device on the main electronic control board, configured to admit external light to achieve automatic headlight control.

Further, the main electronic control board and the secondary electronic control board adopt a vertically stacked dual-board structure and are connected via board-to-board mating connectors, specifically comprising: a main electronic control board pin male connector and a main electronic control board pin male connector disposed on the main electronic control board; a secondary electronic control board female connector disposed on the secondary electronic control board, the secondary electronic control board female connector being mated respectively with the main electronic control board pin male connector and the main electronic control board pin male connector; a main electronic control board fastening screw, configured to secure the main electronic control board to an inner side of the upper cover assembly; a plurality of secondary electronic control board fastening screws, configured to secure the secondary electronic control board to an inner side of the lower cover; wherein the top of the secondary electronic control board female connector is provided with a physical travel-limiting structure configured to mate with the main electronic control board pin male connector and the main electronic control board pin male connector, configured to prevent excessive or insufficient mating engagement.

Further, the secondary electronic control board serves as a harness interface integration board disposed below the main electronic control board, comprising: a headlight wire male connector, disposed on the secondary electronic control board, configured to connect to the headlight harness and to relay headlight electrical signals to the main electronic control board; a button wire female connector, disposed on the secondary electronic control board, configured to connect to the button harness and to relay button signals to the main electronic control board; a controller wire female connector, disposed on the secondary electronic control board, configured to connect to the main control harness and to establish communication with the external controller; an electronic control board waterproof silicone gasket, disposed between the secondary electronic control board and the lower cover and arranged around the interface area, configured to cooperate with waterproof silicone grease to seal the harness pass-through area; wherein the lower cover is respectively provided with a headlight wire pass-through hole, a main wire pass-through hole, and a button wire pass-through hole, corresponding respectively to the headlight harness, the main control harness, and the button harness passing therethrough.

Further, the interior of the stem body forms concealed wire routing channels, comprising: a stem main wire routing slot, formed on one side of the bottom of the stem body, configured to provide positional constraint and guidance for the pass-through location of the main control harness; a stem button wire routing slot, formed on another side of the bottom of the stem body, configured to provide positional constraint and guidance for the pass-through location of the button harness; a stem headlight wire routing slot, formed on a side of the stem body proximate to the headlight assembly, configured to provide positional constraint and guidance for the pass-through location of the headlight harness; a headlight wire internal pass-through hole, formed inside the stem body and communicating the space where the instrument assembly is located with the space where the headlight assembly is located, configured to achieve concealed routing of the headlight harness inside the stem body; wherein the headlight wire internal pass-through hole extends in a downwardly inclined direction so as to prevent external moisture from entering the interior of the stem body along the harness path.

Further, the communication mode between the instrument assembly and the external controller is at least one of a universal asynchronous receiver/transmitter (UART) serial communication mode, a controller area network (CAN) bus communication mode, or a Bluetooth wireless communication mode; the instrument assembly is simultaneously equipped with a UART serial interface and a CAN bus interface, and is configured to automatically identify the communication protocol with the external controller upon power-up, specifically comprising: simultaneously monitoring communication signals on the UART serial interface and the CAN bus interface; determining, based on protocol characteristics of the monitored communication signals, whether the external controller employs a UART serial communication protocol or a CAN bus communication protocol; upon determination of the communication protocol, locking the corresponding communication mode and performing data exchange with the external controller in accordance with the locked communication mode; wherein the instrument assembly is further configured to manually select the communication mode via a Bluetooth APP, and/or to identify the communication mode by means of different connectors.

Further, in the UART serial communication mode, the instrument assembly serves as a communication master station to conduct polling communication with the external controller, specifically comprising: transmitting data packets to the external controller at a preset cycle, the data packets including system parameter setting packets and operating data packets; wherein the system parameter setting packets carry pedal-assist sensor parameters, speed sensor parameters, throttle parameters, battery parameters, current limit values, speed limit values, wheel diameter information, and handshake verification bytes, and the operating data packets carry an output power upper limit value corresponding to a current assist level and vehicle status information; upon a rider switching the assist level, looking up a power percentage corresponding to the current assist level from a level-to-power mapping table pre-stored in the instrument, and converting the power percentage into a pulse-width modulation (PWM) value acceptable to the external controller; inserting the converted PWM value into the operating data packet and transmitting it to the external controller, so that the external controller uses the PWM value as an upper limit value of the current loop output; receiving a reply data packet returned by the external controller; the reply data packet including a current value, a time required for one revolution of a wheel, a fault code, an undervoltage status, a cruise status, and a handshake verification reply value; if no correct reply data packet is received for a plurality of consecutive preset cycles, determining a communication interruption and outputting communication fault information.

Further, in the CAN bus communication mode, the instrument assembly serves as a node in a vehicle-wide CAN network to communicate with at least one of an external controller, a battery management system (BMS), a sensor, a derailleur, an electronic lock, an ABS module, and a Bluetooth module, and participates in vehicle-wide network management, specifically comprising: receiving node query information transmitted by a master station, and determining the online status of each node based on status information returned by each node; detecting the online/offline status of each node during an operating phase, and updating network node status information when a node status changes; receiving and displaying at least one of real-time speed, current, voltage, controller temperature, motor temperature, current assist level, boost status, speed limit value, battery level, and remaining range data transmitted by the external controller; when the battery management system (BMS) is online, obtaining at least one of total capacity, remaining capacity, state-of-charge percentage, current, voltage, and temperature battery data from the battery management system (BMS); when the battery management system (BMS) is not online, obtaining estimated battery level and voltage information from the external controller; automatically switching the battery data source based on the node online status, and using the switched data as the current display data source.

The advantages of the present invention are as follows:
(1) The present invention centralizes the instrument assembly, headlight assembly, headlight harness, main control harness, and button harness at the stem body, and combines a dual electronic control board structure, concealed wire routing channels, waterproof sealing structures, and a heat dissipation structure, so that the previously distributed instrument, headlight, and related connection components achieve an integrated arrangement, thereby eliminating complex wiring, reducing exposed harnesses, improving the structural compactness and overall appearance consistency of the stem area, and reducing the manufacturing cost of the vehicle.
(2) In the present invention, the instrument assembly can support a UART serial communication mode, a CAN bus communication mode, and a Bluetooth wireless communication mode, and can implement level-to-power mapping, polling communication, and handshake verification in the UART serial communication mode, and can implement node status management and automatic data source switching in the CAN bus communication mode, thereby advantageously improving the adaptability between the instrument and different controllers, as well as the vehicle-wide operating information exchange, communication security, and system coordinated control capability.

### BRIEF DESCRIPTION OF THE DRAWINGS

In order to more clearly illustrate the technical solutions in the embodiments of the present invention or in the prior art, a brief introduction will be given below to the drawings required for use in the embodiments. Obviously, the drawings described below are merely some embodiments of the present invention, and for those of ordinary skill in the art, other drawings can be obtained from these drawings without creative effort.

FIG. 1 is an assembly schematic diagram of the instrument assembly in the instrument-stem integrated system according to an embodiment of the present invention;

FIG. 2 is an assembly schematic diagram of the instrument assembly from another angle in the instrument-stem integrated system according to an embodiment of the present invention;

FIG. 3 is a structural schematic diagram of the instrument-stem integrated system according to an embodiment of the present invention;

FIG. 4 is a structural schematic diagram from another angle of the instrument-stem integrated system according to an embodiment of the present invention;

FIG. 5 is an assembly schematic diagram of the instrument assembly in the instrument-stem integrated system according to an embodiment of the present invention;

FIG. 6 is a top view of the instrument-stem integrated system according to an embodiment of the present invention;

FIG. 7 is a cross-sectional view taken along section B-B of FIG. 6;

FIG. 8 is a front view of the instrument-stem integrated system according to an embodiment of the present invention;

FIG. 9 is a partial enlarged view at D in FIG. 8.

In the figures, the reference numbers are listed below.

1 - main electronic control board;

2 - secondary electronic control board;

3 - main electronic control board 9-pin male connector;

4 - main electronic control board 7-pin male connector;

5 - secondary electronic control board female connector;

6 - electronic control board waterproof silicone gasket;

7 - upper cover assembly;

8 - lower cover;

9 - upper-lower cover O-ring seal;

10 - secondary electronic control board fastening screws;

11 - thermal conductive silicone pad;

12 - upper-lower cover fastening screws;

13 - headlight wire male connector;

14 - button wire female connector;

15 - controller wire female connector;

16 - headlight wire routing hole;

17 - main wire routing hole;

18 - button wire routing hole;

19 - main electronic control board fastening screw;

20 - photoresistor light-sensing aperture;

21 - instrument assembly;

22 - stem body;

23 - headlight metal housing;

24 - headlight harness;

25 - main control harness;

26 - button harness;

27 - stem main wire routing slot;

28 - stem button wire routing slot;

29 - stem headlight wire routing slot;

30 - internal headlight wire routing hole;

31 - headlight locking screws;

32 - stem fastening screw;

33 - heat dissipation grooves;

34 - headlight assembly.

### DETAILED DESCRIPTION OF EMBODIMENTS

To further illustrate the embodiments, the present invention provides drawings that form part of the disclosure, primarily used to illustrate the embodiments and that may be used in conjunction with the relevant descriptions in the specification to explain the operating principles of the embodiments. With reference to these contents, those of ordinary skill in the art should be able to understand other possible implementations and the advantages of the present invention. Components in the drawings are not drawn to scale, and similar component symbols are generally used to represent similar components.

According to an embodiment of the present invention, an instrument-stem integrated system is provided.

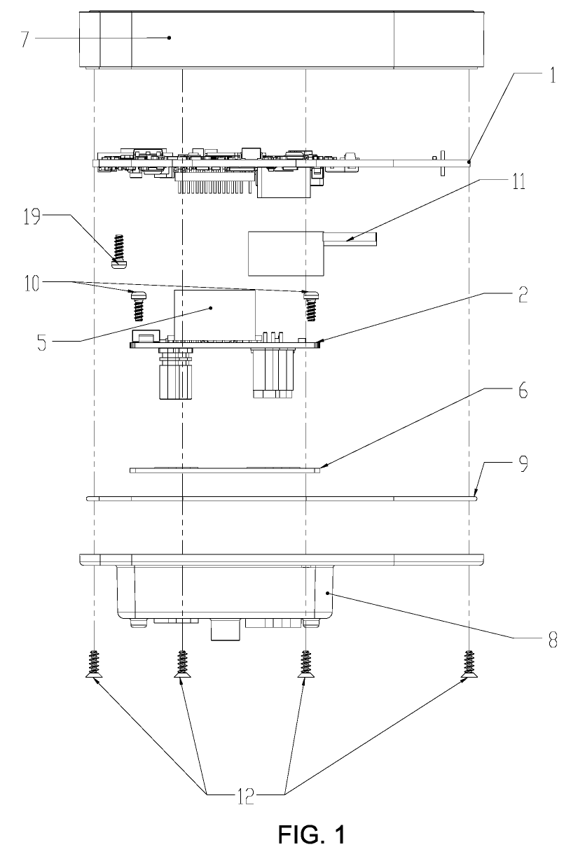

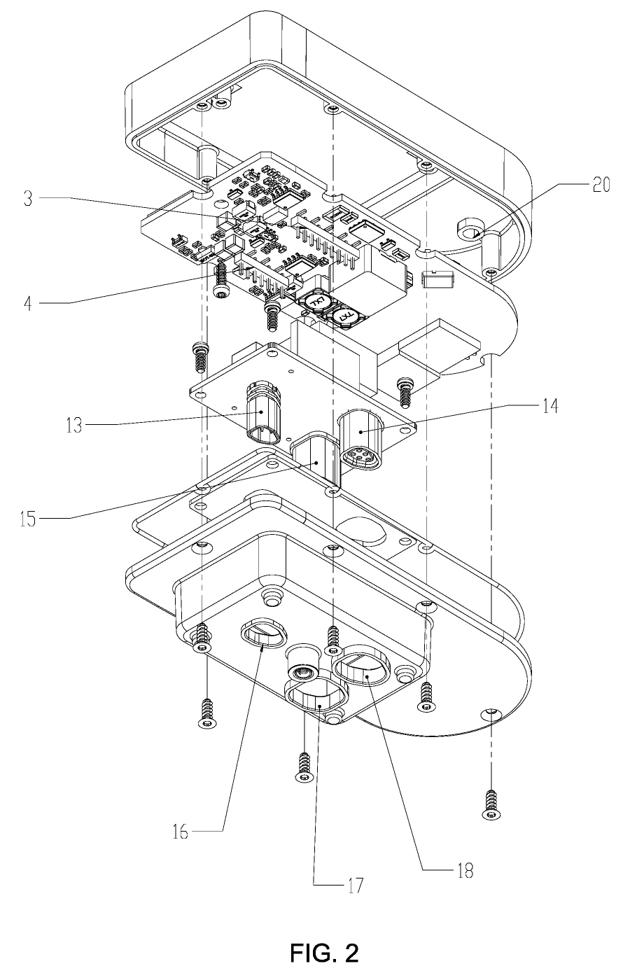

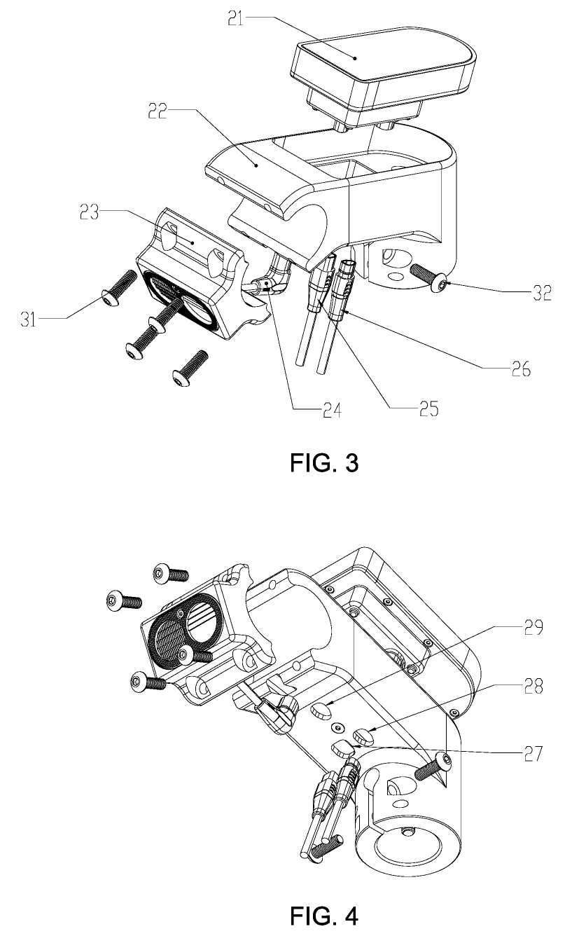

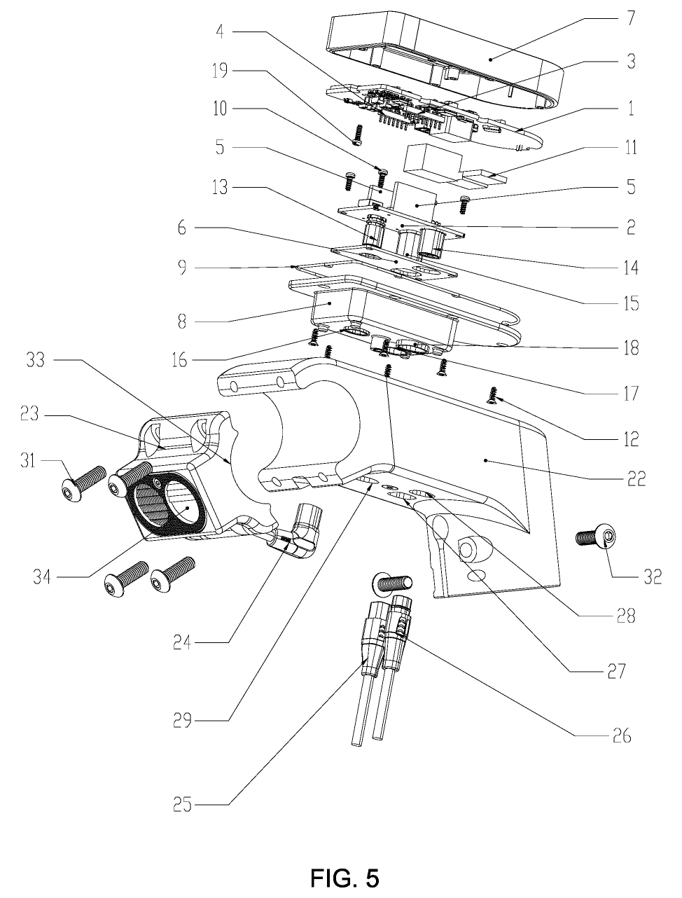

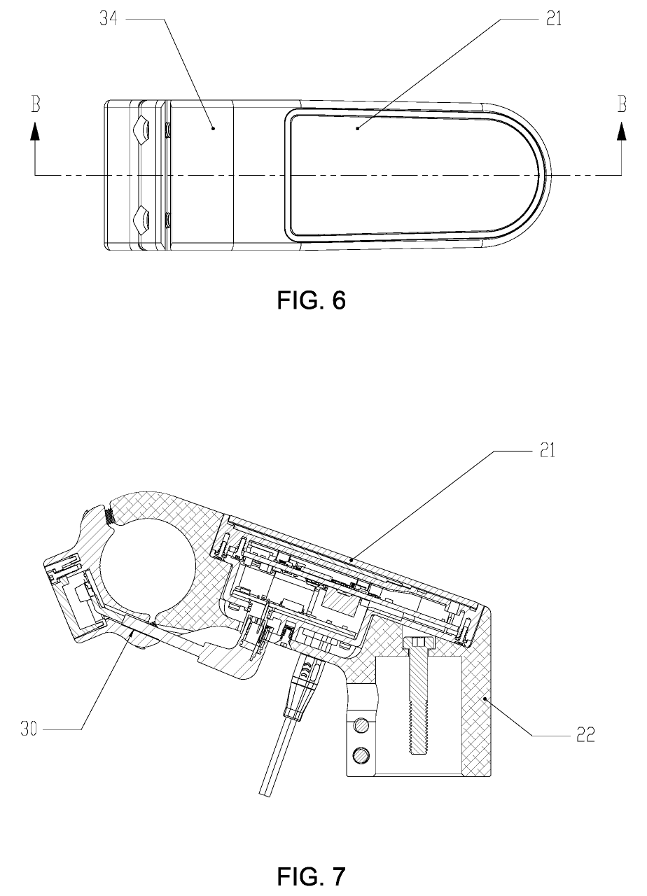

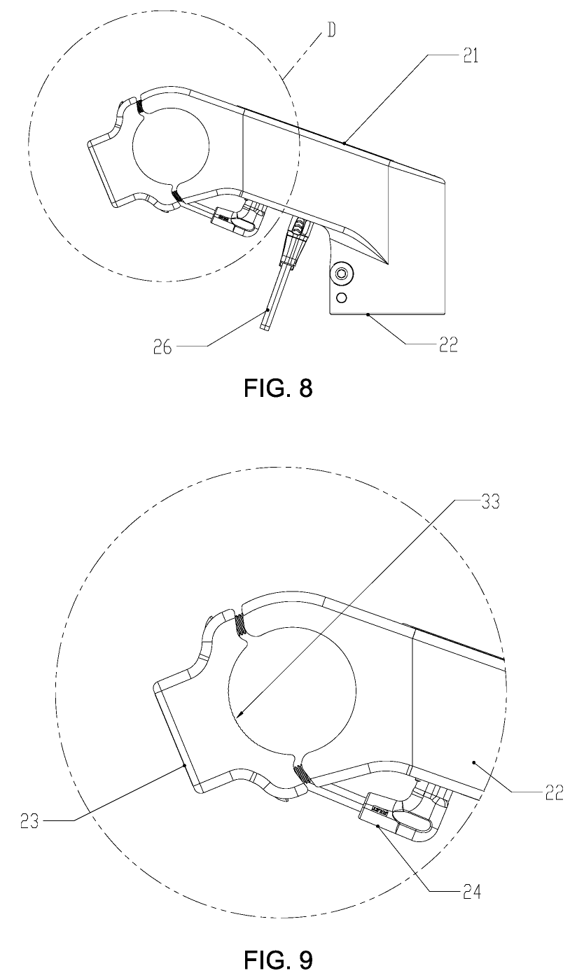

The present invention will now be further described with reference to the accompanying drawings and specific embodiments. As shown in FIGS. 1 to 9, according to one embodiment of the present invention, an instrument-stem integrated system is provided. The instrument-stem integrated system comprises: a stem body 22; the stem body 22 serves as a main structural member of the stem and simultaneously constitutes a mounting housing and a heat dissipation substrate for an instrument assembly 21; the instrument assembly 21 is embedded in a cavity on the inner side of the stem body 22, configured to display vehicle operating information and to execute vehicle-wide control, communication, and unlocking functions; a headlight assembly 34, integrated at a front end of the stem body 22; the headlight assembly 34 comprises a headlight metal housing 23 and a plurality of headlight locking screws 31; a headlight harness 24, a main control harness 25, and a button harness 26, all routed out from the interior of the stem body 22, the headlight harness 24 being configured to connect to a headlight, the main control harness 25 being configured to connect to an external controller, and the button harness 26 being configured to connect to an external button; wherein the instrument assembly 21 comprises a main electronic control board 1 and a secondary electronic control board 2; the main electronic control board 1 is configured to integrate a main control MCU, a Bluetooth module, and an RFID module, the secondary electronic control board 2 is configured to integrate external harness interfaces and to be electrically connected to the main electronic control board 1; and the instrument assembly 21 communicates with an external controller via a harness or wirelessly.

In one embodiment, the instrument assembly 21 further comprises: an upper cover assembly 7, disposed at the uppermost portion of the instrument assembly 21 and covering an upper side of the main electronic control board 1; a lower cover 8, disposed below the upper cover assembly 7 and enclosing together with the upper cover assembly 7 to form a sealed cavity accommodating the main electronic control board 1 and the secondary electronic control board 2; an upper-lower cover O-ring seal 9, disposed between the upper cover assembly 7 and the lower cover 8, configured to provide circumferential waterproof sealing for the sealed cavity; a plurality of upper-lower cover fastening screws 12, passing through between the upper cover assembly 7 and the lower cover 8 to fasten and secure the two together; a photoresistor light-sensing aperture 20, disposed on the upper cover assembly 7 at a position corresponding to a photosensitive device on the main electronic control board 1, configured to admit external light to achieve automatic headlight control.

In one embodiment, the main electronic control board 1 and the secondary electronic control board 2 adopt a vertically stacked dual-board structure and are connected via board-to-board mating connectors, specifically comprising: a main electronic control board 9-pin male connector 3 and a main electronic control board 7-pin male connector 4 disposed on the main electronic control board 1; a secondary electronic control board female connector 5 disposed on the secondary electronic control board 2, the secondary electronic control board female connector 5 being mated respectively with the main electronic control board 9-pin male connector 3 and the main electronic control board 7-pin male connector 4; a main electronic control board fastening screw 19, configured to secure the main electronic control board 1 to an inner side of the upper cover assembly 7; a plurality of secondary electronic control board fastening screws 10, configured to secure the secondary electronic control board 2 to an inner side of the lower cover 8; wherein the top of the secondary electronic control board female connector 5 is provided with a physical travel-limiting structure configured to mate with the main electronic control board 9-pin male connector 3 and the main electronic control board 7-pin male connector 4, configured to prevent excessive or insufficient mating engagement, which saves space compared to disorganized harness connections and is safer and more resistant to high temperatures.

In one embodiment, the secondary electronic control board 2 serves as a harness interface integration board disposed below the main electronic control board 1, comprising: a headlight wire male connector 13, disposed on the secondary electronic control board 2, configured to connect to the headlight harness 24 and to relay headlight electrical signals to the main electronic control board 1; a button wire female connector 14, disposed on the secondary electronic control board 2, configured to connect to the button harness 26 and to relay button signals to the main electronic control board 1; a controller wire female connector 15, disposed on the secondary electronic control board 2, configured to connect to the main control harness 25 and to establish communication with the external controller; an electronic control board waterproof silicone gasket 6, disposed between the secondary electronic control board 2 and the lower cover 8 and arranged around the interface area, configured to cooperate with waterproof silicone grease to seal the harness pass-through area; wherein the lower cover 8 is respectively provided with a headlight wire pass-through hole 16, a main wire pass-through hole 17, and a button wire pass-through hole 18, corresponding respectively to the headlight harness 24, the main control harness 25, and the button harness 26 passing therethrough.

In one embodiment, the interior of the stem body 22 forms concealed wire routing channels, comprising: a stem main wire routing slot 27, formed on one side of the bottom of the stem body 22, configured to provide positional constraint and guidance for the pass-through location of the main control harness 25; a stem button wire routing slot 28, formed on another side of the bottom of the stem body 22, configured to provide positional constraint and guidance for the pass-through location of the button harness 26; a stem headlight wire routing slot 29, formed on a side of the stem body 22 proximate to the headlight assembly 34, configured to provide positional constraint and guidance for the pass-through location of the headlight harness 24; a headlight wire internal pass-through hole 30, formed inside the stem body 22 and communicating the space where the instrument assembly 21 is located with the space where the headlight assembly 34 is located, configured to achieve concealed routing of the headlight harness 24 inside the stem body 22; wherein the headlight wire internal pass-through hole 30 extends in a downwardly inclined direction so as to prevent external moisture from entering the interior of the stem body 22 along the harness path.

In one embodiment, a bottom end of one side of the stem body 22 is provided with a clamping mounting portion configured to connect to a handlebar, and a stem fastening screw 32 is disposed at a locking position of the clamping mounting portion, configured to clamp and secure the handlebar; the stem body 22 and the instrument assembly 21 are secured by means of screws, magnetic attraction, bayonet, or snap-fit; a heat dissipation structure is further disposed between the stem body 22 and the instrument assembly 21, comprising: a thermally conductive silicone pad 11, disposed at a bottom end of the main electronic control board 1, configured to conduct heat generated by circuit board components through the upper cover assembly 7 to the stem body 22; the stem body 22 being made of a metallic material and serving as a heat dissipation substrate for the instrument assembly 21; a plurality of heat dissipation grooves 33, formed on an inner side of the headlight metal housing 23 proximate to one end of the stem body 22, configured to increase the heat dissipation area and to improve air convection heat dissipation efficiency.

In one embodiment, the communication mode between the instrument assembly 21 and the external controller is at least one of a UART serial communication mode, a CAN bus communication mode, or a Bluetooth wireless communication mode; the instrument assembly 21 is simultaneously equipped with a UART serial interface and a CAN bus interface, and is configured to automatically identify the communication protocol with the external controller upon power-up, specifically comprising: simultaneously monitoring communication signals on the UART serial interface and the CAN bus interface; determining, based on protocol characteristics of the monitored communication signals, whether the external controller employs a UART serial communication protocol or a CAN bus communication protocol; upon determination of the communication protocol, locking the corresponding communication mode and performing data exchange with the external controller in accordance with the locked communication mode; wherein the instrument assembly 21 is further configured to manually select the communication mode via a Bluetooth APP, and/or to identify the communication mode by means of different connectors.

In one embodiment, in the UART serial communication mode, the instrument assembly 21 serves as a communication master station to conduct polling communication with the external controller, specifically comprising: transmitting data packets to the external controller at a preset cycle, the data packets including system parameter setting packets and operating data packets; wherein the system parameter setting packets carry pedal-assist sensor parameters, speed sensor parameters, throttle parameters, battery parameters, current limit values, speed limit values, wheel diameter information, and handshake verification bytes, and the operating data packets carry an output power upper limit value corresponding to a current assist level and vehicle status information; upon a rider switching the assist level, looking up a power percentage corresponding to the current assist level from a level-to-power mapping table pre-stored in the instrument, and converting the power percentage into a PWM value acceptable to the external controller; inserting the converted PWM value into the operating data packet and transmitting it to the external controller, so that the external controller uses the PWM value as an upper limit value of the current loop output; receiving a reply data packet returned by the external controller; the reply data packet including a current value, a time required for one revolution of a wheel, a fault code, an undervoltage status, a cruise status, and a handshake verification reply value; if no correct reply data packet is received for a plurality of consecutive preset cycles, determining a communication interruption and outputting communication fault information.

In one embodiment, in the CAN bus communication mode, the instrument assembly 21 serves as a node in a vehicle-wide CAN network to communicate with at least one of an external controller, a battery management system (BMS), a sensor, a derailleur, an electronic lock, an ABS module, and a Bluetooth module, and participates in vehicle-wide network management, specifically comprising: receiving node query information transmitted by a master station, and determining the online status of each node based on status information returned by each node; detecting the online/offline status of each node during an operating phase, and updating network node status information when a node status changes; receiving and displaying at least one of real-time speed, current, voltage, controller temperature, motor temperature, current assist level, boost status, speed limit value, battery level, and remaining range data transmitted by the external controller; when the battery management system (BMS) is online, obtaining at least one of total capacity, remaining capacity, state-of-charge percentage, current, voltage, and temperature battery data from the battery management system (BMS); when the battery management system (BMS) is not online, obtaining estimated battery level and voltage information from the external controller; automatically switching the battery data source based on the node online status, and using the switched data as the current display data source.

In one embodiment, a handshake verification mechanism based on a challenge-and-response method is provided between the instrument assembly 21 and the external controller, specifically comprising: the instrument assembly 21 carrying a random challenge value in the system parameter setting packet and transmitting it to the external controller; the external controller, upon receiving the random challenge value, using the random challenge value as an index to look up a corresponding response value in a pre-stored lookup table, and returning it to the instrument assembly 21 via a reply data packet; the instrument assembly 21 looking up an expected response value from an identical lookup table stored locally according to the random challenge value; comparing the expected response value with the response value returned by the external controller; when the two are consistent, determining that the handshake verification has passed and entering a normal communication state; when the two are inconsistent, determining that the handshake verification has failed and outputting a fault code, so as to refuse to establish normal communication with an unauthorized device.

In one embodiment, in the UART serial communication mode, the instrument assembly 21 is configured to calculate the vehicle speed based on the wheel revolution time transmitted by the external controller and pre-stored wheel diameter parameters, specifically comprising: obtaining the time T required for one revolution of the wheel transmitted by the external controller; performing validity determination on the time T, determining the vehicle to be stationary and setting the speed to 0 when T is 0, and determining the vehicle to be in a low-speed stationary state when T exceeds a preset maximum threshold; when the time T is valid, correcting the time T according to a speed sensor type parameter stored in EEPROM; wherein for sensors installed inside the motor that detect once per revolution, the time T is used directly, and for external sensors installed on the wheel that may detect multiple times per revolution, the time T is corrected by dividing by the number of detections; looking up a corresponding speed coefficient K from a pre-calculated constant table based on the current wheel diameter index number, and calculating the real-time speed as speed = K/T; when the user has set imperial units (mph), performing unit conversion on the calculated real-time speed before display; and calculating maximum speed, average speed, single-trip distance, and total distance based on the real-time speed.

It should be noted that the present invention proposes an instrument-stem integrated system for electric bicycles, comprising a stem body 22 and an intelligent instrument assembly 21 embedded therein; the instrument assembly 21 includes an electronic control board integrating a main control MCU, a Bluetooth module, and an RFID module; the instrument communicates with the controller via a harness or wirelessly. The electronic control board consists of two boards, a main electronic control board 1 and a secondary electronic control board 2, connected by board-to-board connectors (main electronic control board 9-pin male connector 3, main electronic control board 7-pin male connector 4, and secondary electronic control board female connector 5) in a mating configuration; the electronic control board may also have all functions and interfaces integrated on a single PCB, and the electronic control board further integrates a SIM card slot and a GPS positioning chip.

Specifically, the instrument assembly 21 implements electric door lock control via the RFID module and/or the Bluetooth module; the Bluetooth module supports Apple Find My and/or Google Find positioning protocols.

Specifically, the communication method between the instrument assembly 21 and the external controller is at least one of UART, CAN bus, or Bluetooth wireless.

Specifically, the instrument assembly 21 is simultaneously equipped with both UART and CAN interfaces, supporting automatic identification and switching of communication protocols.

Specifically, a handshake verification mechanism is provided between the instrument assembly 21 and the controller, which prevents unauthorized device access through a challenge-response method.

Specifically, in the CAN bus mode, the instrument assembly 21 participates in network management, automatically detects the online/offline status of each node, and automatically switches data sources based on node online status.

Specifically, the instrument assembly 21 receives and classifies fault information reported by all vehicle nodes, and supports fault code storage and historical query.

Specifically, the instrument assembly 21 employs a multi-layer waterproof structure, including an upper-lower cover O-ring seal 9, an electronic control board waterproof silicone gasket 6, and a headlight wire internal pass-through hole 30.

### I. System Overview

It should also be noted that the present invention is an integrated system that completely embeds an intelligent instrument into the interior of a bicycle stem. The instrument, headlight, and control harnesses are all integrated within the stem body 22, with only three harness sets routed externally to connect to the controller, headlight, and buttons. The system comprises: a stem body 22 (aluminum alloy, serving simultaneously as a structural member, housing, and heat dissipation body); an instrument assembly 21 (embedded in the upper cavity of the stem); a headlight assembly 34 (integrated at the front end of the stem); and three harness sets (main control harness 25, headlight harness 24, and button harness 26).

### II. Internal Structure of the Instrument

It should further be noted that the instrument assembly 21 internally adopts a dual electronic control board architecture, specifically comprising:

2.1 Main Electronic Control Board: The main electronic control board 1 is the core of the instrument assembly, integrating the following functional modules: 1) Main control MCU: responsible for all logic control, display driving, and communication processing; 2) Bluetooth module (BLE 5.0/5.4): communicates with a mobile phone APP, supports parameter setting, riding data synchronization, and OTA firmware upgrade; also supports Apple Find My/Google Find positioning tracking protocols; 3) RFID read/write module + antenna: implements RFID card proximity unlock/lock; 4) SIM card slot + GPS positioning chip (optional configuration): supports 4G network real-time positioning and remote locking; 5) LCD display driver: drives a color LCD display; 6) LED driver circuit: controls the headlight LED module, supporting high/low beam switching; 7) Photoresistor: senses ambient light through the photoresistor light-sensing aperture 20 on the housing to automatically control the headlight; 8) CAN transceiver: supports CAN bus communication; 9) UART serial interface: supports conventional serial communication protocol. The main electronic control board is provided with two sets of board-to-board male connectors for mating with the secondary electronic control board.

2.2 Secondary Electronic Control Board: The function of the secondary electronic control board 2 is a harness interface integration board, which integrates the interfaces of three external harness sets onto a single PCB, including: a headlight wire male connector 13, connected to the headlight harness 24; a button wire female connector 14, connected to the external button harness 26; and a controller wire female connector 15, connected to the main control harness 25. Specifically, the secondary electronic control board 2 and the main electronic control board 1 are connected via board-to-board connectors (main electronic control board 9-pin male connector 3, main electronic control board 7-pin male connector 4, and secondary electronic control board female connector 5) in a mating configuration, with connectors equipped with physical travel limiters. The purpose of the dual-board architecture in the present invention is to save internal space, improve assembly efficiency, and provide more reliable connections that are resistant to vibration.

### III. Communication Between Instrument and Controller

3.1 Dual Interface Design: The instrument assembly 21 is simultaneously equipped with both UART serial and CAN bus communication interfaces and is compatible with controllers on the market that employ different communication protocols.

3.2 UART Serial Communication Mode: The instrument actively transmits data packets to the controller at fixed time intervals, and the controller replies with current operating data upon receipt. If no controller reply is received after a set time, the instrument determines a communication fault and displays a prompt on the screen.

The instrument transmits two types of data packets to the controller:
1) System parameter setting packets, including pedal-assist sensor parameters (number of magnets, assist ratio, assist direction), speed sensor parameters (number of magnets, soft-start intensity), throttle parameters (multi-level mode, walk-assist speed-limiting mode), battery parameters (undervoltage reference value, undervoltage offset value), current limit value, speed limit value, wheel diameter information, and handshake verification bytes.
2) Normal operating packets, i.e., the instrument assembly 21 transmits the current operating state to the controller, including output power upper limit value and vehicle status. The output power upper limit value means that the instrument does not directly transmit a level number but rather transmits the power upper limit value corresponding to that level, and the controller controls motor output according to this upper limit value. In walk-assist mode, an extremely low upper limit value is transmitted to limit speed. Vehicle status includes headlight switch, turn signals, walk-assist mode, assist/throttle switching, cruise switch, overspeed flag, etc.

The multi-level mode refers to dividing electric assist into several discrete levels (assist levels), with each level corresponding to a fixed power upper limit percentage. The rider switches between adjacent levels step by step via buttons. The characteristics of the multi-level mode are: 1) Discrete leveling: power is not continuously adjustable and can only be switched among predefined levels; 2) Configurable number of levels: supports multiple level quantity configurations (e.g., 3-level, 5-level, 9-level), selectable via Bluetooth APP; 3) The power percentage of each level can be independently set: different percentage values can be set for each level via Bluetooth APP; 4) Default startup level is configurable: the instrument automatically enters the level at which it was last powered off; 5) Speed limit linkage: while transmitting the power upper limit, the instrument also monitors speed based on the current speed limit setting. When the real-time speed approaches the speed limit value, the instrument gradually reduces the PWM value transmitted to the controller, achieving smooth deceleration.

Specifically, the walk-assist speed-limiting mode, also known as walking assistance mode, is a special low-speed drive mode independent of the multi-level mode, used to provide electric assist when the rider dismounts and pushes the electric bicycle.

Specifically, the distinguishing characteristics between the walk-assist speed-limiting mode and the multi-level mode in the present invention are as follows: 1) Different activation methods: in multi-level mode, levels are switched step by step via buttons, and the level remains after switching until switched again; in walk-assist mode, a designated button on the instrument is pressed and held to activate, and the motor output stops immediately upon release; 2) Different power output: in multi-level mode, power percentages of each level range from low to full power; in walk-assist mode, a preset low-power PWM value (approximately 20% duty cycle) is fixedly transmitted, driving the motor only with extremely low torque. This value is not affected by level settings and cannot be modified by the user; 3) Different speed limits: in multi-level mode, the instrument is subject to the set maximum speed limit value (depending on regulations and vehicle model configuration); in walk-assist mode, the speed is hard-limited to walking speed (approximately 6 km/h), unaffected by the multi-level mode speed limit settings; 4) Different safety designs: in multi-level mode, the motor continues output as set after level switching, without requiring the button to be held; in walk-assist mode, a press-to-drive, release-to-stop switch design (commonly known as a dead man's switch) is employed, ensuring that the rider must always be holding the vehicle to enable walk assist, preventing vehicle runaway; 5) Different applicable scenarios: in multi-level mode, the rider rides on the vehicle, controlling the motor through the pedal-assist sensor or throttle; in walk-assist mode, the rider is on foot, pushing the vehicle uphill or through complex terrain. Meanwhile, the speed limit of the walk-assist speed-limiting mode complies with the walking assistance speed requirements of the EU EN15194 standard and the Chinese GB17761 standard.

It should be supplemented that under the UART serial communication mode in the present invention, the instrument assembly 21 does not directly transmit a level number to the controller, but rather converts the level into a power upper limit value, i.e., a PWM duty cycle value, and transmits it to the controller via a data packet. The controller uses this value as the upper limit of the field-oriented control (FOC) current loop output. The specific implementation steps are as follows:

Step 1: The instrument internally pre-stores multiple sets of level-to-power mapping tables, corresponding to different level quantity configurations (e.g., 3-level, 5-level, 9-level, etc.). Each mapping table maps each level number to a power percentage value. The user selects which level configuration to use via the Bluetooth APP or instrument settings menu.

Step 2: When the rider switches levels via buttons, the instrument looks up the corresponding power percentage from the current level configuration table and converts it proportionally to an integer PWM value acceptable to the controller.

The design features of the mapping table are: Level 0 (off) corresponds to a power percentage of 0%, at which time the motor produces no output; low levels correspond to smaller percentages (low motor power output), and high levels correspond to larger percentages (high motor power output); the highest level corresponds to 100% (motor at full power output according to the controller current limit value); the percentage values of each level maintain a reasonable gradient between adjacent levels to ensure the rider perceives a noticeable assist difference when switching; the above percentage values can be customized via the Bluetooth APP to suit different vehicle models and motor characteristics.

Step 3: The instrument inserts the converted PWM value into the UART data packet and transmits it to the controller at a fixed cycle. Auxiliary control information such as lighting status is also carried in the same data packet.

Step 4: Upon receiving the PWM upper limit value, the controller uses it as the clamping value of the current loop PID controller output. When the PID calculation result exceeds this upper limit, the output is forcibly limited to the upper limit value. The PWM duty cycle determines the equivalent voltage applied to the motor windings through the three-phase inverter bridge; the greater the duty cycle, the higher the equivalent voltage, and the greater the motor speed and torque. The technical effect of this design in the present invention is: the controller does not need to understand the level concept and only needs to execute simple power upper limit restriction. All level logic and user interaction are handled by the instrument, reducing the software complexity on the controller side, and also enabling the same controller to work with different instruments without modifying the controller firmware.

Specifically, the data replied by the controller includes: battery status, i.e., whether undervoltage exists; cruise status; real-time current; speed information, i.e., the controller transmits the time required for one wheel revolution, and the instrument calculates speed based on the known wheel diameter, a design that transfers speed calculation from the controller to the instrument side; fault codes, including current anomaly, throttle anomaly, motor phase loss, Hall sensor anomaly, brake anomaly, etc.; and handshake verification reply value.

It should be supplemented that the instrument assembly 21 in the present invention calculates speed based on wheel diameter. Specifically, under the UART serial communication mode, the controller does not directly calculate and transmit a speed value, but rather transmits the time T required for one wheel revolution to the instrument via a data packet. The instrument calculates real-time speed based on pre-stored wheel diameter parameters. For each revolution of the wheel, the distance traveled by the vehicle equals the circumference of the wheel C = π × D. Given the time T for one wheel revolution, the instantaneous vehicle speed V = C/T.

Specifically, the instrument internally stores a wheel diameter lookup table containing multiple common electric bicycle wheel diameter specifications (from small-diameter folding bicycles to large-diameter commuter bicycles). The user selects the installed tire specification via the Bluetooth APP or instrument menu, and the instrument stores the corresponding index number in EEPROM. Each wheel diameter specification corresponds to a pre-calculated speed coefficient K, where K = wheel circumference × unit conversion constant. Pre-calculations are stored as integer constants in the firmware to avoid floating-point operations at runtime.

Specifically, the steps for calculating speed based on wheel diameter in the instrument assembly 21 of the present invention are as follows:

Step 1: Obtaining raw data: The controller measures the time T for one wheel revolution via the motor Hall sensor or an external speed sensor. The time value is encoded as a 16-bit unsigned integer (unit: milliseconds) and placed into the UART reply data packet for transmission to the instrument assembly 21.

Step 2: Data validity determination: Upon receiving the T value, the instrument assembly 21 first determines its validity: if T = 0, indicating that the sensor has not detected rotation, the vehicle is determined to be stationary and speed is set to 0; if T exceeds a preset maximum threshold (corresponding to extremely low speed), the speed is determined to be too low and treated as a stationary state; if T is within the valid range, proceed to Step 3.

Step 3: Speed sensor type correction: Based on the speed sensor type parameter stored in EEPROM: for internal sensors installed inside the motor that detect once per revolution, the T value is used directly; for external sensors installed on the wheel that may detect multiple times per revolution, the T value is divided by the number of detections for correction.

Step 4: Table lookup for speed calculation: The instrument assembly 21 looks up the corresponding speed coefficient K from the pre-calculated constant table based on the current wheel diameter index number, and calculates speed: speed = K/T; the result unit is 0.1 km/h.

Step 5: Unit conversion and display: If the user has set imperial units (mph), the instrument assembly 21 multiplies the metric speed by the conversion factor (1 km/h ≈ 0.6213 mph) before display.

Step 6: Statistical data calculation: Based on the real-time speed value, the instrument assembly 21 also calculates the following statistical data: maximum speed, i.e., continuously comparing the real-time speed with the historical maximum and retaining the greater value, stored in EEPROM; average speed, i.e., total riding distance divided by total riding time; distance accumulation, i.e., numerically integrating the real-time speed at fixed time intervals and accumulating to single-trip distance and total distance.

Specifically, under the CAN bus communication mode, the controller directly transmits the already-calculated speed value (accuracy 0.01 km/h), and the instrument assembly 21 does not need to perform calculation and directly displays it. Under both modes, the instrument assembly 21 can correctly display speed; the only difference is the execution location of the speed calculation: under UART mode it is calculated by the instrument assembly 21, and under CAN mode it is calculated by the controller.

3.3 CAN Bus Communication Mode: Specifically, the instrument assembly 21 serves as one node in the CAN network, communicating with multiple nodes including the controller, battery BMS, sensors, derailleur, electronic lock, ABS, and Bluetooth module. The network supports up to 16 nodes simultaneously online.

Specifically, three communication modes include: broadcast messages, transmitted by the master station controller, used for network management (node query, status broadcast); point-to-point messages, one-to-one communication between any two nodes, used for parameter read/write, i.e., a request-response mode; and publish-style messages, periodically broadcast by each node as public information, receivable by any node.

Specifically, data received by the instrument assembly 21 includes: data from the controller, i.e., real-time speed, current, voltage, controller temperature, motor temperature, current assist level, boost status, speed limit value, wheel diameter, tire circumference, calories, remaining battery level, remaining range, and shutdown notification; data from the battery BMS, i.e., total capacity, remaining capacity, SOC (state-of-charge percentage), SOH (state-of-health), current, voltage, temperature, charging status, and heating status; data from sensors, i.e., torque signal and cadence; and data from other nodes, i.e., ABS status, derailleur gear, and electronic lock status.

Specifically, data transmitted by the instrument assembly 21 includes: riding mode selection, including multiple modes; assist level (supporting multiple configurations such as 3-level, 5-level, 9-level); headlight status and button status; total distance, single-trip distance, maximum speed, and average speed; maintenance distance reminder; auto-shutoff time, light sensitivity, and backlight level.

It should further be supplemented that the motor assist control in the present invention is divided into two hierarchical levels: riding mode (Mode) and assist level (Level). The riding mode is a top-level control strategy that determines the overall response characteristics and parameter set of the motor; the assist level is a further subdivision of power grades within a given riding mode.

In the present invention, the instrument assembly 21 is pre-configured with two riding modes (expandable via Bluetooth APP), each mode defining an independent parameter set, including: 1) Commuting Mode, with the objective of balancing range and comfort, suitable for daily urban commuting; parameter characteristics include a lower response threshold for pedal-assist sensor sensitivity, commuting parameter set for power percentages at each level, and a typically more conservative speed limit setting; the mode effect is smooth motor startup, comfortable riding feel, and longer range. 2) Off-road Mode, with the objective of maximum power output, suitable for mountains, uphill, and other high-load scenarios; parameter characteristics include a higher response threshold for pedal-assist sensor sensitivity, off-road parameter set for power percentages at each level, and the ability to set higher speed limit values; the mode effect is more responsive motor, faster acceleration, and greater torque. The core difference between the two modes lies in different pedal-assist sensor sensitivity parameters. The sensitivity parameter determines the response speed and force curve from detection of pedaling to motor output; the higher the sensitivity, the faster the motor engages after pedaling and the greater the output; the lower the sensitivity, the more gradual the motor engagement and the softer the output.

In the present invention, the riding mode defines a parameter set including sensitivity and speed limit parameters, and the assist level defines a power grade within that parameter set. The riding mode and the multi-level mode switch independently without interfering with each other. For example: a rider may use the highest assist level in commuting mode to obtain maximum power under commuting sensitivity, or use the lowest assist level in off-road mode to obtain minimum power under off-road sensitivity.

Under the UART communication mode, the instrument assembly 21 places the riding mode parameters and the assist level power values into different types of data packets for transmission, including: system parameter setting packets, carrying riding mode-related parameters (sensitivity, speed limit, etc.), transmitted upon mode switching or parameter changes; and operating data packets, carrying the PWM power upper limit value corresponding to the current assist level, transmitted at a fixed cycle (every 0.5 seconds). The walk-assist speed-limiting mode is independent of the above riding modes and multi-level mode, being a special safety mode unaffected by mode and level settings.

Specifically, different data in the present invention employ different transmission frequencies: critical data such as speed and current are transmitted at high frequency to ensure real-time performance, while non-critical data such as distance and calories are transmitted at low frequency to reduce bus load. When the data volume exceeds single-frame capacity, a segmented transmission mechanism (start frame → transfer frame → end frame) is employed, supporting read/write of large-capacity parameter groups, such as controller parameter configurations (battery parameters, motor parameters, sensor parameters, torque parameters, etc.).

3.4 Handshake Verification and Anti-Counterfeiting: Specifically, a handshake verification mechanism is provided between the instrument assembly 21 and the controller to prevent unauthorized third-party devices from accessing the system. Specifically: the instrument assembly 21 transmits a random challenge value, the controller performs calculation based on an internally pre-stored key and returns a verification value, and the instrument assembly 21 verifies the correctness of the returned value. Normal communication proceeds only after verification passes; if verification fails, the connection is refused. This mechanism ensures that the instrument assembly 21 and the controller must be used as a paired set and can be extended to higher security-level schemes such as dynamic keys, symmetric encryption, Bluetooth binding authentication, RFID authorization activation, and cloud-based online authentication.

3.5 Network Management (CAN Mode): Specifically, under the CAN bus mode, the instrument participates in vehicle-wide network management, including: startup phase: the master station queries all nodes for online status and broadcasts each node's status to the entire network; operating phase: the master station periodically queries node online/offline status, and newly online nodes actively notify; automatic battery data switching: when an independent battery BMS is online in the network, the instrument obtains detailed battery data from the BMS; when no BMS is present, the instrument assembly 21 obtains estimated battery level from the controller. This switching is automatic and requires no manual configuration.

3.6 Fault Diagnosis System: Specifically, the instrument assembly 21 receives and displays fault information reported by all vehicle nodes, with faults classified into the following categories: controller faults, i.e., overcurrent, overvoltage, undervoltage, throttle anomaly, motor faults (phase loss/Hall sensor/overtemperature), controller overtemperature, current sensor fault, brake detection fault, speed sensor fault, headlight fault, power detection fault, etc.; battery faults, i.e., total voltage too high/too low, total current too high, single cell voltage anomaly, temperature anomaly, SOC anomaly, battery short circuit, temperature differential, single cell voltage differential, etc.; sensor faults, i.e., torque signal fault, speed signal fault; and other faults, i.e., derailleur jammed/unable to reset, electronic lock jammed, Bluetooth module fault, communication fault.

The fault reporting mechanism is: a node immediately reports upon detecting a fault, transmits a clear signal when the fault disappears, and the instrument assembly 21 supports fault code storage and historical query for retrieval by diagnostic tools.

3.7 Automatic Protocol Identification: Specifically, after power-up, the instrument assembly 21 simultaneously monitors both the UART and CAN interfaces, automatically identifies the protocol type used by the controller and locks it. It can also be manually selected via the Bluetooth APP, or automatically identified via different connectors.

It should be noted that the CAN bus communication mode of the present application is based on the CAN 2.0B extended frame standard, employing a 29-bit frame identifier (ID) at a bus rate of 250 Kbit/s. Supplementary descriptions are provided below in five aspects: frame ID encoding, network management, data dictionary, segmented transmission, and emergency messages:

(1) Extended frame ID encoding structure: The protocol performs application-layer encoding on the 29-bit frame ID of the CAN 2.0B standard, dividing it into five functional fields: source node ID field, identifying the sender node number; destination node ID field, identifying the receiver node number; command code field, identifying the operation type of the frame (write command, read command, normal response, error response, long data start, long data transfer, long data end, status code, etc.); index field (AFN), identifying the group category of the target object in the data dictionary; and sub-index field (FN), identifying the specific parameter number of the target object within the group.

Specifically, through this encoding structure, each CAN frame ID fully expresses the complete information of "who sends to whom, what operation, and which parameter," enabling the receiving node to decide whether to accept the frame without parsing the data field, thereby improving bus efficiency.

(2) Multi-node network management: The protocol supports multi-node network communication. Each node is assigned a unique number, and node types cover: sensor, motor controller, instrument assembly 21, battery BMS, debugging tool, derailleur, electronic lock, Bluetooth module, and other electronic subsystems on an electric bicycle.

The network management mechanism is as follows: 1) Startup node discovery: After the master station (motor controller) powers up, it sequentially transmits query frames to each possible node number within a set time, waiting for each node to return its operating status. Non-responsive nodes are marked as not online. After the query is complete, the master station broadcasts the online and operating status of all nodes to the entire network. 2) Runtime node monitoring: During normal operation, the master station repeats the node query at fixed time intervals (approximately 1 minute) to detect whether any nodes have come online or gone offline. If the status changes, the master station re-broadcasts the updated network-wide node status. 3) Active node online notification: When a node powers up and joins the network during system operation, the node actively transmits an online alert message, and the master station immediately broadcasts the node status change upon receipt. 4) Degraded operation: When a non-critical node (e.g., battery BMS) is not online, its function is taken over by the master station (controller). For example: when the battery is not online, the instrument assembly 21 reads battery level and voltage information from the controller rather than directly from the battery.

Communication modes are divided into three types: broadcast messages, transmitted by the master station to all nodes (highest priority), used for network management commands; point-to-point messages, one-to-one communication between any two nodes, used for parameter read/write; and publish-style messages, published by any node to the entire network (broadcast style), used for sharing public information (e.g., real-time speed, current, etc.), receivable by all nodes.

(3) Data dictionary and parameter read/write: The protocol manages all communicable parameters of the vehicle via a data dictionary mechanism. The data dictionary uses an index (AFN) and sub-index (FN) to compose a two-dimensional address space, with each address corresponding to a specific parameter.

Specifically, indexes are grouped by function, mainly including: network settings group: baud rate, node address, and other network configuration parameters; alert message group: fault and alert information of each node; remote upgrade group: firmware upgrade-related parameters; publish-style data group: operating data periodically published by each node (speed, current, temperature, etc.); and vehicle data object group: controller parameters, instrument parameters, battery parameters, and other configuration-type data.

Specifically, each parameter defines a name, data type, unit, data length, read/write permission, and factory default value; parameter read/write follows a client-server model (C/S), i.e., a request-response method; write operation: the client transmits a write command frame (carrying the index, sub-index, and data to be written), the server verifies and executes the write, and returns a normal response; if the parameter is invalid, an error response with an abort code is returned; read operation: the client transmits a read command frame (carrying the index and sub-index), and the server returns the current value of the corresponding parameter. For parameters whose data length does not exceed the CAN data frame capacity (8 bytes), accelerated transfer (single frame completion) is used. For parameters exceeding 8 bytes, the segmented transmission mechanism is used.

(4) Segmented transmission mechanism: When the data volume to be transmitted exceeds the 8-byte payload capacity of the CAN data frame, the segmented transmission mechanism is used to split the large data block into multiple CAN frames for sequential transmission. Segmented transmission involves three frame types, distinguished by the command code field in the frame ID: start frame, identifying the beginning of a segmented transmission and carrying the first set of data; transfer frame (intermediate frame), carrying subsequent data segments, with the frame containing a frame sequence number (SEQ) that increments from 0 for each frame; and end frame, identifying the end of the transmission and carrying the last data segment.

Specifically, the complete flow of a segmented write operation in the present invention is as follows:

Step 1: Initiating a write request: The client transmits a write command frame, with the data field containing the index number of the target parameter and the total byte count of the data to be written.

Step 2: Server verification and confirmation: The server verifies whether the index number and sub-index number are valid. If valid, a normal response is returned; if invalid, an error response is returned carrying an abort code explaining the error reason.

Step 3: Transmitting the start frame: The client transmits the start frame, with the data field being the first 8 bytes of the data to be written.

Step 4: Cyclically transmitting transfer frames: The client sequentially transmits transfer frames, each carrying 8 bytes of data with the frame sequence number incrementing by 1 for each frame. Upon receiving each frame, the server checks sequence continuity: if the sequence number is correct, the data is buffered and a normal response is returned; if the sequence number is non-continuous, frame loss is determined, an error response is returned, and the transmission is terminated.

Step 5: Transmitting the end frame: The client transmits the end frame, with the data field being the final remaining data bytes.

Step 6: Final confirmation and write: Upon receiving the end frame, the server compares the total bytes received with the total length declared in Step 1. If consistent, the complete data is written to non-volatile storage and a normal response is returned; if inconsistent, all data is discarded and the transmission fails.

(5) Timeout and retry mechanism: During segmented transmission, the sender waits for the receiver's response after transmitting each frame. If no response is received after timeout, the sender retransmits the current frame; if no response is still received after exceeding the maximum retry count, the sender aborts the current transmission and reports a communication fault to the upper-layer application. The receiver also maintains a timeout timer during transmission. If no subsequent frames are received after timeout following the start frame, the receiver automatically discards the buffered data and returns to the idle state.

(6) Emergency Message (EMCY) mechanism: When any subsystem of the vehicle detects a fault, that node transmits an emergency message (Emergency Message) via the CAN bus. Emergency messages have high priority in the frame ID encoding and take precedence over normal data frames in bus arbitration. Each fault type is assigned a unique fault code. Fault codes are grouped by subsystem, mainly including controller faults, i.e., overcurrent, overvoltage, undervoltage, overtemperature, phase loss, Hall sensor anomaly, brake sensor anomaly, startup failure, watchdog reset, etc.; battery faults, i.e., overcharge, over-discharge, short circuit, temperature anomaly, communication interruption, etc.; sensor faults, i.e., torque sensor anomaly, speed sensor anomaly, etc.; and communication faults, i.e., node offline, data checksum failure, etc. The message is transmitted immediately upon fault occurrence, without waiting for the polling cycle. Upon receiving an emergency message, the instrument assembly 21 displays the corresponding fault code on the LCD screen and may decide whether to restrict vehicle operation based on the fault severity level.

(7) Handshake verification mechanism of the UART serial communication protocol: Under the UART serial communication mode, a handshake verification mechanism is provided between the instrument assembly 21 and the controller to prevent unauthorized third-party instruments or controllers from accessing the vehicle system.

Specifically, the handshake mechanism in the present invention employs a challenge-response method, specifically:

Step 1: The instrument assembly 21 initiates a challenge: The instrument carries a random number in the system parameter setting packet and transmits it to the controller.

Step 2: The controller performs a table lookup response: Upon receiving the random number, the controller uses the random number as an index to look up the corresponding response value in a pre-stored lookup table, and returns it to the instrument assembly 21 via the reply packet.

Step 3: The instrument verifies the response: The instrument assembly 21 locally maintains an identical lookup table. The instrument assembly 21 uses the same random number to look up the expected response value from the table and compares it with the value actually returned by the controller. If they match, the handshake succeeds and the instrument assembly 21 enters the normal operating state; if they do not match, the instrument assembly 21 determines that the controller has failed verification and displays a fault code.

Through this mechanism in the present invention, only controllers that have pre-stored the correct lookup table can pass the verification of the instrument assembly 21, effectively preventing unauthorized components from accessing the system; the contents of the lookup table are proprietary data and are not publicly released.

Furthermore, to completely disclose the technical solution of the UART mode, the frame structure and communication flow of the present invention are supplementarily described as follows:

The UART serial communication employs an asynchronous serial communication standard with parameters of: 9600 baud rate, 8 data bits, no parity bit, 1 stop bit (9600N81). The basic structure of all frames is: start delimiter + address byte + frame type identifier + valid data length + data field + checksum (double byte) + end delimiter.

The start delimiter and end delimiter are fixed values used for frame delineation; the frame type identifier distinguishes between the two frame types of system parameter setting packets and operating data packets; the checksum is the cumulative sum of all bytes from the address byte to the end of the data field, taking the lower 16 bits, transmitted as high and low bytes; the receiver calculates the checksum and compares it with the value carried in the frame, discarding the frame if they do not match.

Specifically, in the present invention, the instrument assembly 21 serves as the communication master station and the controller serves as the slave station. The communication flow is:
1) The instrument assembly 21 transmits a data packet to the controller every 0.5 seconds. The data packet type alternates between system parameter setting packets and operating data packets, or the frame type is selected based on the current operational need.
2) Upon receiving a correct data packet, the controller immediately returns a reply packet to the instrument assembly 21. The reply packet carries current operating status information, including: current value, wheel revolution time (for speed calculation), fault code, undervoltage status, cruise status, controller version, etc.
3) If the instrument assembly 21 continuously transmits a set number of data packets (approximately 10 seconds) without receiving a correct controller reply, the instrument assembly 21 determines a communication interruption and displays a communication fault code on the LCD screen.

Through this half-duplex polling architecture, the present invention ensures real-time monitoring of the communication link: disconnection by either party can be detected within seconds.

IV. Mechanical Structural Connection

Specifically, in the present invention, the instrument assembly 21 is embedded in the mounting cavity on the upper portion of the stem body 22: the upper cover assembly 7 and lower cover 8 are secured by upper-lower cover fastening screws 12 to form a sealed housing; the instrument assembly 21 housing is embedded into the stem body 22 through mechanical fitting and secured by screws; the main electronic control board 1 and secondary electronic control board 2 are each secured within the housing by dedicated screws.

Specifically, the instrument assembly 21 employs a four-layer waterproof design: the first layer is a fully sealed housing formed by the O-ring seal between the upper and lower covers; the second layer is sealing at the pass-through holes formed by the electronic control board waterproof silicone gasket 6 and insulating waterproof silicone grease; the third layer is the downwardly inclined angle design of the pass-through holes, utilizing gravity to prevent water from entering along harnesses; and the fourth layer is the internal pass-through hole design for the headlight wire, i.e., the wiring path is entirely inside the stem, completely sealed.

Specifically, the heat dissipation path of the instrument assembly 21 is: circuit board components → thermally conductive silicone pad 11 → instrument upper cover assembly 7 → metal stem body 22 → heat dissipation grooves 33 → atmosphere; utilizing the aluminum alloy material of the stem itself as a heat dissipation body, with heat dissipation grooves 33 on the stem surface to increase heat dissipation area, requiring no fan, and achieving entirely passive heat dissipation.

Specifically, the headlight metal housing 23 is secured to the front end of the stem by screws; the headlight harness 24 is connected to the instrument electronic control board through the headlight wire internal pass-through hole 30 inside the stem; routing is entirely inside the stem and invisible from the exterior; the routing avoids heat dissipation areas, and the downward routing angle effectively prevents water ingress; the headlight is automatically controlled by the photoresistor, and can also be manually controlled via buttons or the APP.

Specifically, the stem body 22 is provided with three dedicated pass-through holes (main control/headlight/button), with three harness sets routed out separately, and the pass-through holes employ sealing gaskets and a downwardly inclined angle design.

### V. Instrument Functions

Specifically, the present invention features display functions, control functions, and intelligent functions.

The display functions include: real-time vehicle speed, battery level and health, single-trip and total distance, remaining rideable range, current assist level and riding mode, real-time power, cadence and torque, controller and motor temperature, calorie consumption, average and maximum speed, navigation information, fault codes and alerts, headlight status, ABS status, and maintenance distance reminder.

The control functions include: assist level switching (supporting multiple level configurations), riding mode switching (multiple riding modes), headlight on/off and high/low beam, turn signal control, electric door lock (RFID/Bluetooth/APP), speed limit mode switching, walk-assist mode, cruise mode, single-trip distance reset, parameter setting (remotely modifying controller parameters via Bluetooth APP), auto-shutoff time, light sensitivity, and backlight brightness adjustment.

The intelligent functions include: RFID keyless unlock, Bluetooth APP connection, Apple Find My/Google Find positioning, GPS real-time positioning and remote locking (optional), automatic headlight, OTA firmware upgrade, multi-protocol automatic identification, handshake anti-counterfeiting verification, and network node management.

### VI. Electronic Lock Implementation

The present invention features three unlocking methods, including RFID unlock: an RFID card is brought near the instrument assembly 21 → read and verified → an unlock command is transmitted to the controller; Bluetooth unlock: the mobile phone APP transmits an unlock command → transmitted via Bluetooth to the instrument assembly 21 → forwarded to the controller; remote unlock (optional): the cloud transmits a command via 4G → GPS module → instrument assembly 21 → controller. Additionally, pairing of multiple RFID cards is supported, managed via diagnostic tools or the Bluetooth APP.

It should be noted that the following variants all fall within the scope of protection of the present invention, and the core inventive concept of integrating an intelligent instrument into the interior of a stem remains unchanged.

Specifically, the integration method of the instrument and stem includes, in addition to the top-embedded type: bottom-embedded type, front-embedded type, wrap-around type (flexible OLED), split-embedded type, drawer/removable type, clamp type, and integrally cast type; the housing fixing method includes, in addition to screws: magnetic attraction, bayonet rotary locking, spring snap-fit, threaded insertion, Pogo Pin + magnetic attraction composite, guide rail + latch, and interference fit; the circuit board architecture includes, in addition to dual-board: single-board integration, three-board stacking, rigid-flex board, modular plug-in, and direct wire-out; the communication method includes, in addition to UART and CAN wired: Bluetooth wireless, 2.4G proprietary protocol wireless, and wired + wireless hybrid; the headlight integration method includes, in addition to the stem front end: top integration, side dual lights, light ring surround, foldable, removable (also serving as flashlight), and separate wire-controlled; the harness routing includes, in addition to dedicated pass-through holes: hollow steerer tube routing, surface channel, single comprehensive connector, and partial wireless; the stem form is applicable to multiple forms including: conventional round tube, integrated handlebar-stem, height-adjustable, folding, irregular cross-section, carbon fiber, and double-layer sandwich structure; the waterproof solution includes, in addition to O-ring + silicone gasket: ultrasonic welding, potting compound encapsulation, dual-chamber isolation, nano-coating, and touch replacement of button openings; and the verification solution includes, in addition to lookup table: AES symmetric encryption, one-time password (TOTP), public key encryption, Bluetooth binding authorization, RFID authorization activation, and cloud-based authentication.

The above descriptions are merely preferred embodiments of the present invention, and are not intended to limit the present invention. Any modifications, equivalent substitutions, and improvements made within the spirit and principles of the present invention shall be included within the scope of protection of the present invention.

1. An instrument-stem integrated system, comprising:
a stem body, serving as a main structural member of a stem and simultaneously constituting a mounting housing and a heat dissipation substrate for an instrument assembly;
the instrument assembly, embedded in a cavity on an inner side of the stem body, configured to display vehicle operating information and to execute vehicle-wide control, communication, and unlocking functions;
a headlight assembly, integrated at a front end of the stem body, comprising a headlight metal housing and a plurality of headlight locking screws;
a headlight harness,
a main control harness, and
a button harness,
wherein the headlight harness, the main control harness, and the button harness are routed out from an interior of the stem body, the headlight harness is configured to connect to a headlight, the main control harness is configured to connect to an external controller, and the button harness is configured to connect to an external button;
the instrument assembly comprises a main electronic control board and a secondary electronic control board; the main electronic control board is configured to integrate a main control microcontroller unit (MCU), a Bluetooth module, and a radio frequency identification (RFID) module, the secondary electronic control board is configured to integrate external harness interfaces and to be electrically connected to the main electronic control board; and the instrument assembly communicates with the external controller via a harness or wirelessly.

2. The instrument-stem integrated system according to claim 1, wherein the instrument assembly further comprises:
an upper cover assembly, disposed at an uppermost portion of the instrument assembly and covering an upper side of the main electronic control board;
a lower cover, disposed below the upper cover assembly and enclosing together with the upper cover assembly to form a sealed cavity accommodating the main electronic control board and the secondary electronic control board;
an upper-lower cover O-ring seal, disposed between the upper cover assembly and the lower cover, configured to provide circumferential waterproof sealing for the sealed cavity;
a plurality of upper-lower cover fastening screws, passing through between the upper cover assembly and the lower cover to fasten and secure the upper cover assembly and the lower cover;
a photoresistor light-sensing aperture, disposed on the upper cover assembly at a position corresponding to a photosensitive device on the main electronic control board, configured to admit external light to achieve automatic headlight control.

3. The instrument-stem integrated system according to claim 2, wherein the main electronic control board and the secondary electronic control board adopt a vertically stacked dual-board structure and are connected via board-to-board mating connectors, specifically comprising:
a main electronic control board 9-pin male connector and a main electronic control board 7-pin male connector disposed on the main electronic control board;
a secondary electronic control board female connector disposed on the secondary electronic control board, wherein the secondary electronic control board female connector is mated respectively with the main electronic control board 9-pin male connector and the main electronic control board 7-pin male connector;
a main electronic control board fastening screw, configured to secure the main electronic control board to an inner side of the upper cover assembly;
a plurality of secondary electronic control board fastening screws, configured to secure the secondary electronic control board to an inner side of the lower cover;
wherein a top of the secondary electronic control board female connector is provided with a physical travel-limiting structure configured to mate with the main electronic control board 9-pin male connector and the main electronic control board 7-pin male connector, configured to prevent excessive or insufficient mating engagement.

4. The instrument-stem integrated system according to claim 3, wherein the secondary electronic control board serves as a harness interface integration board disposed below the main electronic control board, comprising:
a headlight wire male connector, disposed on the secondary electronic control board, configured to connect to the headlight harness and to relay headlight electrical signals to the main electronic control board;
a button wire female connector, disposed on the secondary electronic control board, configured to connect to the button harness and to relay button signals to the main electronic control board;
a controller wire female connector, disposed on the secondary electronic control board, configured to connect to the main control harness and to establish communication with the external controller;
an electronic control board waterproof silicone gasket, disposed between the secondary electronic control board and the lower cover and arranged around an interface area, configured to cooperate with waterproof silicone grease to seal a harness pass-through area;
wherein the lower cover is respectively provided with a headlight wire pass-through hole, a main wire pass-through hole, and a button wire pass-through hole; the headlight harness, the main control harness, and the button harness pass through the headlight wire pass-through hole, the main wire pass-through hole, and the button wire pass-through hole.

5. The instrument-stem integrated system according to claim 1, wherein the interior of the stem body forms concealed wire routing channels, comprising:
a stem main wire routing slot, formed on a first side of a bottom of the stem body, configured to provide positional constraint and guidance for a pass-through location of the main control harness;
a stem button wire routing slot, formed on a second side of the bottom of the stem body, configured to provide positional constraint and guidance for a pass-through location of the button harness;
a stem headlight wire routing slot, formed on a side of the stem body proximate to the headlight assembly, configured to provide positional constraint and guidance for a pass-through location of the headlight harness;
a headlight wire internal pass-through hole, formed inside the stem body and communicating a space where the instrument assembly is located with a space where the headlight assembly is located, configured to achieve concealed routing of the headlight harness inside the stem body;
wherein the headlight wire internal pass-through hole extends in a downwardly inclined direction so as to prevent external moisture from entering the interior of the stem body along a harness path.

6. The instrument-stem integrated system according to claim 5, wherein a bottom end of one side of the stem body is provided with a clamping mounting portion configured to connect to a handlebar, and a stem fastening screw is disposed at a locking position of the clamping mounting portion, configured to clamp and secure the handlebar;
the stem body and the instrument assembly are secured by screws, magnetic attraction, bayonet, or snap-fit;
a heat dissipation structure is further disposed between the stem body and the instrument assembly, comprising:
a thermally conductive silicone pad, disposed at a bottom end of the main electronic control board, configured to conduct heat generated by circuit board components through an upper cover assembly to the stem body; the stem body being made of a metallic material and serving as a heat dissipation substrate for the instrument assembly;
a plurality of heat dissipation grooves, formed on an inner side of the headlight metal housing proximate to one end of the stem body, configured to increase a heat dissipation area and to improve air convection heat dissipation efficiency.

7. The instrument-stem integrated system according to claim 1, wherein a communication mode between the instrument assembly and the external controller is at least one of a universal asynchronous receiver/transmitter (UART) serial communication mode, a controller area network (CAN) bus communication mode, or a Bluetooth wireless communication mode;
the instrument assembly is simultaneously equipped with a UART serial interface and a CAN bus interface, and is configured to automatically identify a communication protocol with the external controller upon power-up, specifically comprising:
simultaneously monitoring communication signals on the UART serial interface and the CAN bus interface;
determining, based on protocol characteristics of the communication signals, whether the external controller employs a UART serial communication protocol or a CAN bus communication protocol;
upon determination of the communication protocol, correspondingly locking the communication mode and performing data exchange with the external controller in accordance with the communication mode;
wherein the instrument assembly is further configured to manually select the communication mode via a Bluetooth APP, and/or to identify the communication mode by different connectors.

8. The instrument-stem integrated system according to claim 7, wherein in the UART serial communication mode, the instrument assembly serves as a communication master station to conduct polling communication with the external controller, specifically comprising:
transmitting data packets to the external controller at a preset cycle, wherein the data packets include system parameter setting packets and operating data packets; the system parameter setting packets carry pedal-assist sensor parameters, speed sensor parameters, throttle parameters, battery parameters, current limit values, speed limit values, wheel diameter information, and handshake verification bytes, and the operating data packets carry an output power upper limit value corresponding to a current assist level and vehicle status information;
upon a rider switching the assist level, looking up a power percentage corresponding to the current assist level from a level-to-power mapping table pre-stored in the instrument assembly, and converting the power percentage into a pulse-width modulation (PWM) value acceptable to the external controller;
inserting the PWM value into the operating data packet and transmitting the operating data packet to the external controller, wherein the external controller uses the PWM value as an upper limit value of the current loop output;
receiving a reply data packet returned by the external controller, wherein the reply data packet includes a current value, a time required for one revolution of a wheel, a fault code, an undervoltage status, a cruise status, and a handshake verification reply value;
if no correct reply data packet is received for a plurality of consecutive preset cycles, determining a communication interruption and outputting communication fault information.

9. The instrument-stem integrated system according to claim 7, wherein in the CAN bus communication mode, the instrument assembly serves as a node in a vehicle-wide CAN network to communicate with at least one of the external controller, a battery management system (BMS), a sensor, a derailleur, an electronic lock, an ABS module, and a Bluetooth module, and participates in vehicle-wide network management, specifically comprising:
receiving node query information transmitted by a master station, and determining an online/offline status of each node based on status information returned by each node;
detecting the online/offline status of each node during an operating phase, and updating network node status information when a node status changes;
receiving and displaying at least one of real-time speed, current, voltage, controller temperature, motor temperature, current assist level, boost status, speed limit value, battery level, and remaining range data transmitted by the external controller;
when the battery management system (BMS) is online, obtaining at least one of total capacity, remaining capacity, state-of-charge percentage, current, voltage, and temperature battery data from the battery management system (BMS);
when the battery management system (BMS) is not online, obtaining estimated battery level and voltage information from the external controller;
automatically switching a battery data source based on a node online status, and using switched data as a current display data source.

10. The instrument-stem integrated system according to claim 8, wherein a handshake verification mechanism based on a challenge-and-response method is provided between the instrument assembly and the external controller, specifically comprising:
the instrument assembly carrying a random challenge value in the system parameter setting packet and transmitting the random challenge valu to the external controller;
the external controller, upon receiving the random challenge value, using the random challenge value as an index to look up a corresponding response value in a pre-stored lookup table, and returning the corresponding response value to the instrument assembly via a reply data packet;
the instrument assembly looking up an expected response value from an identical lookup table stored locally according to the random challenge value;
comparing the expected response value with the corresponding response value returned by the external controller;
when the expected response value and the corresponding response value are consistent, determining that a handshake verification has passed and entering a normal communication state;
when the expected response value and the corresponding response value are inconsistent, determining that the handshake verification has failed and outputting a fault code to refuse to establish normal communication with an unauthorized device.
